(19) United States
(12) Patent Application Publication
(10) Pub. No.: US 2025/0309542 A1
(43) Pub. Date: Oct. 2, 2025

(54) SATELLITE MODEM

(71) Applicant: Fleet Space Technologies Pty Ltd, Beverley, South Australia (AU)

(72) Inventors: Mohmed SALAH, Beverley, South Australia (AU); Zahra ESMATI, Beverley, South Australia (AU); Anatol AUSIANIK, Beverley, South Australia (AU)

(21) Appl. No.: 18/869,212

(22) PCT Filed: May 26, 2022
(86) PCT No.: PCT/AU2022/050510

§ 371 Date: Nov. 25, 2024

(51) Int. Cl. H01Q 9/04; H01Q 21/06; H04B 1/40; H04L 5/14

(52) U.S. Cl. CPC H01Q 9/0428; H01Q 21/065; H04B 1/40; H04L 5/14

(57) ABSTRACT

A satellite modem, including: a housing; a processor in the housing; a memory in the housing and accessible by the processor; a communications module in the housing and responsive to the processor to communicate with a local external device; an antenna mounting structure mounted in the housing; a transmit patch antenna disposed on the antenna mounting structure and configured to transmit uplink data from the local external device to a satellite; a receive patch antenna disposed on the antenna mounting structure and configured to receive downlink data from the satellite; and a power input connection on the housing to receive power from an external power source and to supply power from the external power source to the processor, the communications module, the transmit patch antenna, and the receive patch antenna; wherein the processor is configured to operate the transmit patch antenna and the receive patch antenna in full duplex.

### TECHNICAL FIELD

Embodiments relate to satellite modems and satellite communication systems and methods. In particular, embodiments relate to terrestrial modem systems for communicating with one or multiple orbiting satellites.

### BACKGROUND

A satellite modem is used to transfer data to and receive data from a satellite. Some satellite modems can be expensive. Some satellite modems may require established infrastructure to function. Some satellite modems may be difficult to use in remote areas. Some satellite modems may be difficult to integrate into existing serial communications networks or with existing devices.

It is desired to address or ameliorate one or more shortcomings or disadvantages of prior satellite modems, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a satellite modem. The satellite modem may include: a housing; a processor in the housing; a memory in the housing and accessible by the processor; a communications module in the housing and responsive to the processor to communicate with a local external device; an antenna mounting structure mounted in the housing; a transmit patch antenna disposed on the antenna mounting structure and configured to transmit uplink data from the local external device to a satellite; a receive patch antenna disposed on the antenna mounting structure and configured to receive downlink data from the satellite; and a power input connection on the housing to receive power from an external power source and to supply power from the external power source to the processor, the communications module, the transmit patch antenna, and the receive patch antenna; wherein the transmit patch antenna and the receive patch antenna are configured to have a passive gain of 3.0 to 5.5 dBi; and wherein the processor is configured to operate the transmit patch antenna and the receive patch antenna in full duplex.

In some embodiments, the transmit patch antenna may be configured to operate at a different frequency range to the receive patch antenna.

The transmit patch antenna may be configured to operate at a frequency range of about 1970 MHz to about 2010 MHz. The receive patch antenna may be configured to operate at a frequency range of about 2170 MHz to about 2200 MHz.

The transmit patch antenna and the receive patch antenna may be right hand polarised. The transmit patch antenna and the receive patch antenna may be passive antennae.

The transmit patch antenna may be configured to operate in at least one of an L band and an S band frequency range. The receive patch antenna may be configured to operate in an S band frequency range.

In some embodiments, the transmit patch antenna and the receive patch antenna may be formed of a hydrocarbon ceramic laminate. The transmit patch antenna and the receive patch antenna may be printed onto the antenna mounting structure. The transmit patch antenna and the receive patch antenna may have an approximate square shape.

In some embodiments, two opposing corners of the approximate square shape of the transmit patch antenna are cut off at a 45° angle resulting in opposing cut edges, and wherein the cut edges have a length of about 4.525 mm. The transmit patch antenna may have a length and a width of 38.9 mm.

In some embodiments, two opposing corners of the approximate square shape of the receive patch antenna are cut off at a 45° angle resulting in two cut edges, and wherein the cut edges have a length of about 4.525 mm. The receive patch antenna may have a length and a width of about 35.45 mm.

In some embodiments, the satellite modem may further include a signal generator configured to generate a radiofrequency signal, and an up-converter to shift the generated radiofrequency signal from a first band to a higher second band.

In some embodiments, the satellite modem may further include a down-converter to shift a received radiofrequency signal from a first band to a lower second band, and a demodulator to demodulate the shifted received radiofrequency signal.

In some embodiments, the satellite modem may further include a global positioning system (GPS) module in the housing, responsive to the processor to allow the processor to determine a geospatial position of the satellite modem.

In some embodiments, the housing may include a base and a cover coupled to the base, wherein the base includes mounting feet for mounting the housing to an external surface.

### BRIEF DESCRIPTION OF DRAWINGS

Embodiments are described in further detail below, by way of example and with reference to the accompanying drawings, in which:

FIG. 1 shows a schematic diagram of an example satellite modem system, according to some embodiments;

FIG. 2A is a top perspective view of an assembled housing of a satellite modem, according to some embodiments;

FIG. 2B is a bottom perspective view of the assembled housing of FIG. 2A;

FIG. 3 is an exploded perspective view of a satellite modem, according to some embodiments;

FIG. 4A is a top perspective view of an antenna board of a satellite modem, according to some embodiments;

FIG. 4B is a bottom perspective view of the antenna board of FIG. 4A;

FIG. 4C is a top view of an antenna board of the satellite modem of FIG. 4A;

FIG. 5 is a schematic diagram of a patch antenna, according to some embodiments;

FIG. 6 is a diagram of a signal processing flow performed by receive circuitry, according to some embodiments; and

FIG. 7 is a diagram of a signal processing flow performed by transmit circuitry, according to some embodiments.

### DESCRIPTION OF EMBODIMENTS

Described embodiments generally relate to satellite modems and satellite communication systems and methods. Particular embodiments relate to terrestrial modem systems for communication with orbiting satellites.

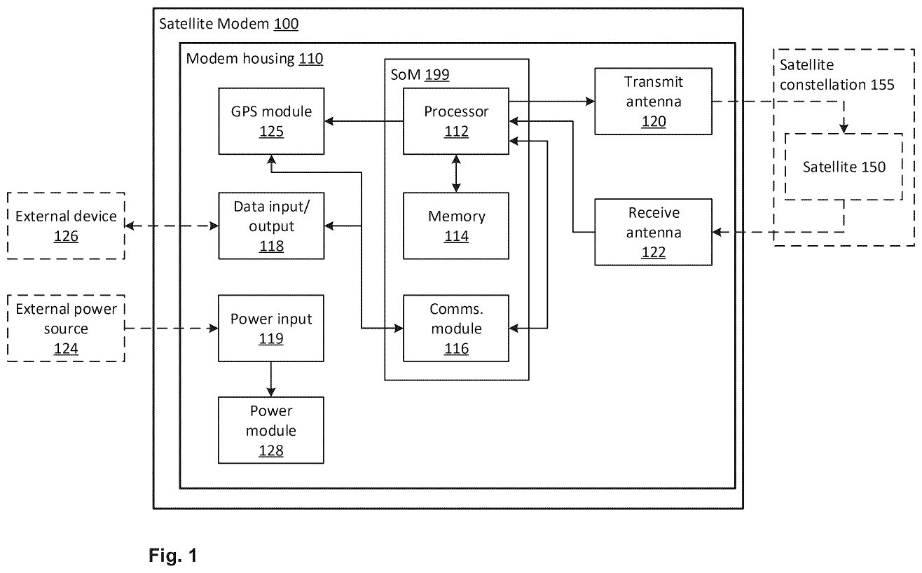

Referring to the drawings, FIG. 1 shows a block diagram of a satellite modem 100 for communication with satellites, according to some embodiments. Satellite modem 100 comprises a modem housing 110. Modem housing 110 is configured to house various components of satellite modem 100. Satellite modem 100 comprises processor circuitry including a processor 112 and a memory 114 accessible to processor 112. Processor 112 is configured to access data stored in memory 114, to execute instructions stored in memory 114, and to read and write data to and from memory 114. Processor 112 may comprise one or more microprocessors, microcontrollers, central processing units (CPUs), application specific instruction set processors (ASIPs), or other processor capable of reading and executing instruction code.

Memory 111 may comprise one or more volatile or non-volatile memory types, such as RAM, ROM, EEPROM, flash, or NAND flash memory, for example. Memory 111 may be configured to store executable applications for execution by processor 110. Memory 111 may comprise between about 500 MB to about 2 GB of volatile memory, for example. In some embodiments, memory 111 may comprise about 1 GB of volatile memory, for example. Memory 111 may comprise between about 2 GB to about 6 GB of volatile memory, for example. In some embodiments memory 111 may comprise about 4 GB of non-volatile memory, for example.

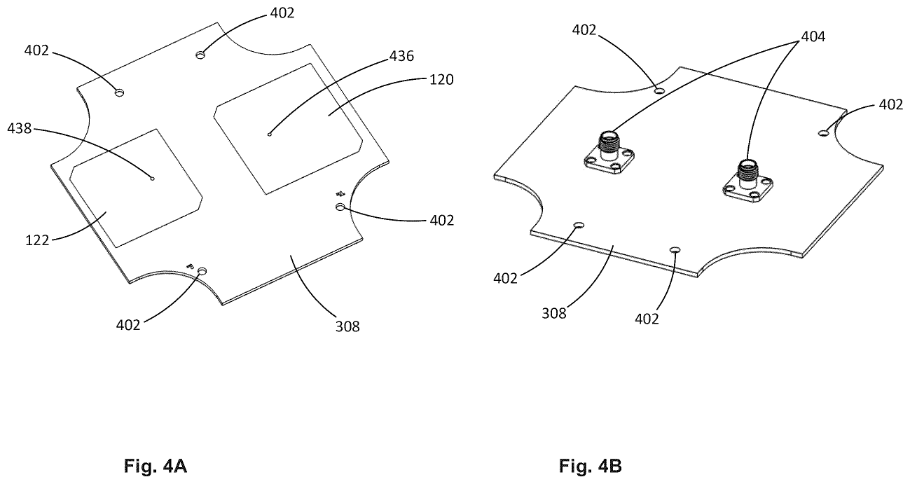

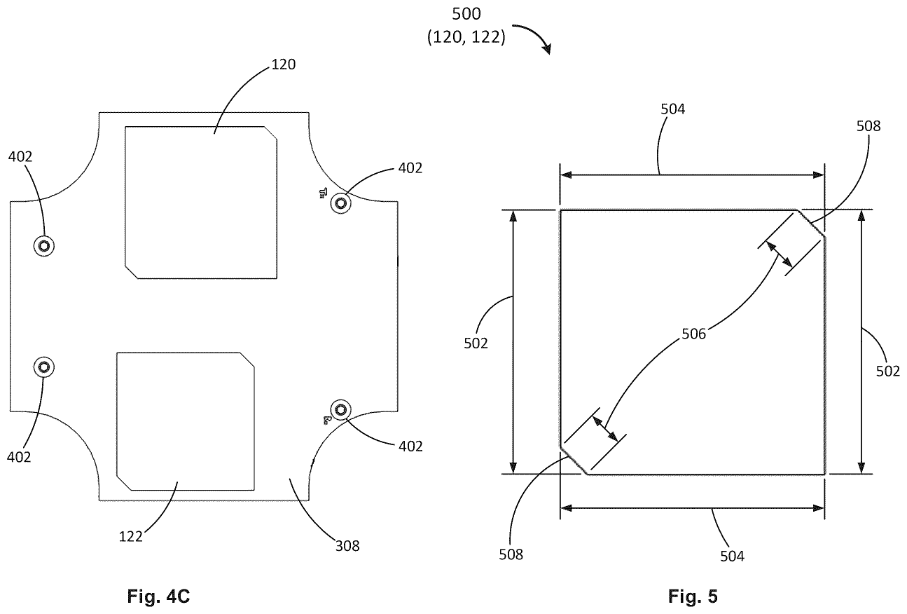

Satellite modem 100 further comprises a transmit antenna 120 and receive antenna 122 for transmitting and receiving, respectively, information data. In some embodiments, the transmit antenna 120 may transmit uplink data. In some embodiments, the receive antenna 122 may receive downlink data. In some embodiments, transmit antenna 120 may be a patch antenna. In some embodiments, receive antenna 122 may be a patch antenna. Satellite modem 100 transmits uplink data to a satellite 150, which may form part of a satellite constellation 155, via transmit antenna 120. Satellite modem 100 receives downlink data from satellite 150 (which may be a different satellite 150 of the satellite constellation 155 from the satellite 150 that received the uplink transmission) via receive antenna 122. In some embodiments, satellite modem 100 is configured to both transmit uplink data and receive downlink data simultaneously. That is, satellite modem 100 has full duplex capability, for example. Both transmit antenna 120 and receive antenna 122 are described further in relation to FIGS. 4A, 4B, 4C, and 5.

In some embodiments, satellite modem 100 may have a transmission range to a satellite 150 of up to about 2000 km, between about 90° elevation and about 10° elevation, respectively, for example. Satellite modem 100 may be able to transmit uplink data, via transmit antenna 120, to a satellite 150 at a range between about 580 km to about 2000 km, for example. In some embodiments, satellite modem 100 may receive downlink data, via receive antenna 122, from satellite 150 at a maximum range of about 2000 km, between about 90° elevation and about 10° elevation, respectively, for example. That is, satellite modem 100 may be able to receive downlink data via receive antenna 122 from satellite 150 at a maximum range of about 2000 km, for example.

To facilitate communication with local external devices, satellite modem 100 further comprises communications circuitry including a communications module 116 contained within modem housing 110. Communications module 116 may allow for wired and/or wireless communication between satellite modem 100 and external device 126. Communications module 116 may facilitate communication via Bluetooth, USB, Wi-Fi, Ethernet, serial communication, or via a telecommunications network, for example. Advantageously, satellite modems according to disclosed embodiments may be simple to integrate into existing serial communications networks or with existing devices.

In some embodiments, communications module 116 may facilitate communication between satellite modem 100 and satellite 150 via a transmit antenna 120 and a receive antenna 122, for example. In some embodiments, processor 112 may cause transmission of uplink data via transmit antenna 120 using communications module 116, for example. In some embodiments, processor 112 may process receipt of downlink data via receive antenna 122 using communications module 116, for example. In some embodiments, satellite modem 100 may comprise a plurality of communications module 116. That is, satellite modem 100 may have a first communications module 116 for communication with local external devices, and a second communications module 116 for communication with satellite 150, for example. In some embodiments, communications module 116 may encode data for transmission to satellite 150 via transmit antenna 120. In some embodiments, communication module 116 may decode data from satellite 150 received via receive antenna 122. Each communications module 116 includes circuitry that may be separate from or integrated with the processor 112.

In some embodiments, satellite modem 100 may further include global positioning system (GPS) circuitry and a GPS module 125. GPS module 125 may utilise a global navigation satellite system (GNNS) that provides geolocation and time information relating to satellite modem 100. In some embodiments, processor 112 may determine, via GPS module 125, a geospatial position of the satellite modem.

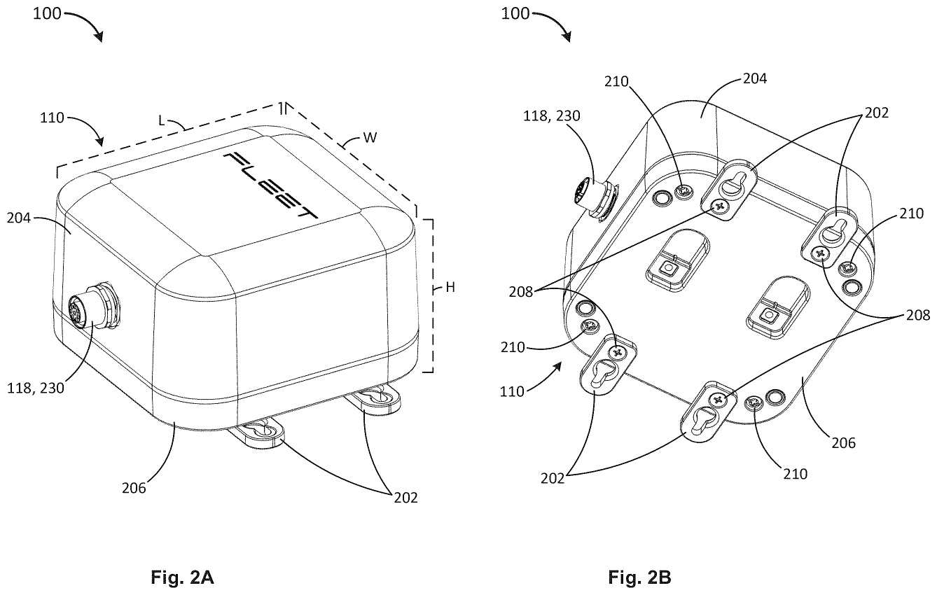

Satellite modem 100 further comprises data input and output (I/O) port 118 to facilitate wired communication between satellite modem 100 and an external device 126. In some embodiments, data I/O port 118 may be used to provide a two-way serial interface with external device 126, for example. External device 126 may be a smart phone, tablet, laptop, PC or other computing device using which a user can send electronic communications to satellite modem 100. In some embodiments, external device 126 may be a local sensor device, such as a seismic vibration sensor, for example. In some embodiments, external device 126 may be a monitoring device, for example. Data I/O port 118 may be a female M12 connector 230 (as shown in FIG. 2), for example. In some embodiments, data I/O port 118 may provide a recommended standard 232 (RS-232) connection for serial communication, for example. That is, serial communication between satellite modem 100 and external device 126 may be defined by RS-232, for example. In some embodiments, the female M12 connector 230 may facilitate serial communication between satellite modem 100 and an external device 126.

Satellite modem 100 further comprises power input 119 to facilitate connection of an external power source 124 to satellite modem 100. That is power input 119 may act as a power input connection to receive electrical power from an external power source 124. External power source 124 may be a battery or a connection to a mains power source. In some embodiments, external power source 124 may be external device 126. In some embodiments, data I/O port 118 and power input 119 may share the female M12 connector 230. That is, the female M12 connector 230 may facilitate both data I/O and power input from an external device 126 and an external power source 124.

Satellite modem 100 further comprises a power module 128 to regulate the received electrical power for distribution to the components of the satellite modem 100. That is, the power module 128 may distribute the received electrical power to any one or more of the processor 112, the memory 114, the communications module 116, the transmit antenna 120, the receive antenna, or the GPS module 125. In some embodiments, external power source 124 may provide 11 volts to 13 volts of electrical power, for example. In some embodiments, the satellite modem is free from an internal power source. In some embodiments, when the satellite modem is neither transmitting uplink data nor receiving downlink data, via the transmit antenna 120 and the receive antenna 122 respectively, its power usage may be about 2 W, for example. In some embodiments, when the satellite modem 100 is transmitting uplink data, via the transmit antenna 120, its power usage may be about 10.6 W, for example. In some embodiments, when the satellite modem 100 is receiving downlink data, via the receive antenna 122, its power usage may be about 3.6 W, for example. In some embodiments, when the satellite modem 100 is both transmitting uplink data and receiving downlink data, via the transmit antenna 120 and the receive antenna 122, its power usage may be about 10.6 W to about 11 W, for example.

FIGS. 2A and 2B are top and bottom perspective views of the satellite modem 100, according to some embodiments. In some embodiments, the modem housing 110 may be an off the shelf commercially available product, such as an ABS plastic enclosure from ‘Hammond manufacturing’, for example. The modem housing 110 is of a radio wave transmissive material, such as a non-conductive material, for example. That is, the modem housing 110 is manufactured from a material that will allow radio waves to travel through it with minimal attenuation, such as plastic, for example.

Modem housing 110 comprises a housing base 206 and a housing cover 204. Housing base 206 is configured to receive the housing cover 204 to create a sealed enclosure that is modem housing 110. In some embodiments, housing cover 204 includes an aperture for receiving data I/O port 118 and/or power input 119. In some embodiments, housing base 206 and housing cover 204 are coupled via a plurality of coupling bolts 210. Coupling bolts 210 may pass through housing base 206 to be received by housing cover 204. Modem housing 110 may comprise four coupling bolts 210, for example. In some embodiments, coupling bolts 210 may be used to mount satellite modem 100 to an external surface or object.

In some embodiments, modem housing 100 may further comprises mounting feet 202. Mounting feet 202 may facilitate mounting of the satellite modem 100 to an external surface or object. Mounting feet 202 may be coupled to the housing base 206 via mounting screw 208. Housing base 206 may further comprise mounting points 212. Mounting feet 202 may be coupled to mounting points 212 to facilitate mounting of the satellite modem 100 to an external surface or object. In some embodiments, modem housing 110 may comprise up to four mounting feet 202 coupled to housing base 206, for example. In some embodiments, mounting feet 202 may have a thickness of about 4.5 mm.

In some embodiments, modem housing 110 may have a height (H as shown in FIG. 2A) of around 60 mm to 80 mm. Modem housing 110 may have a height of about 70 mm, for example. In some embodiments, modem housing 110 may have a length (L as shown in FIG. 2A) and a width (W as shown in FIG. 2A), where the length and width are perpendicular to the height. In some embodiments, the length and the width have a ratio of 1 to 1. In some embodiments, the length and the width have a ratio of 0.9 to 1. In some embodiments, the length and the width have a ratio of 1 to 0.9. The length may be around 120 mm to 145 mm, for example. The width may be around 120 mm to 145 mm, for example. In some embodiments, the length is about 136 mm. In some embodiments, the width is about 136 mm.

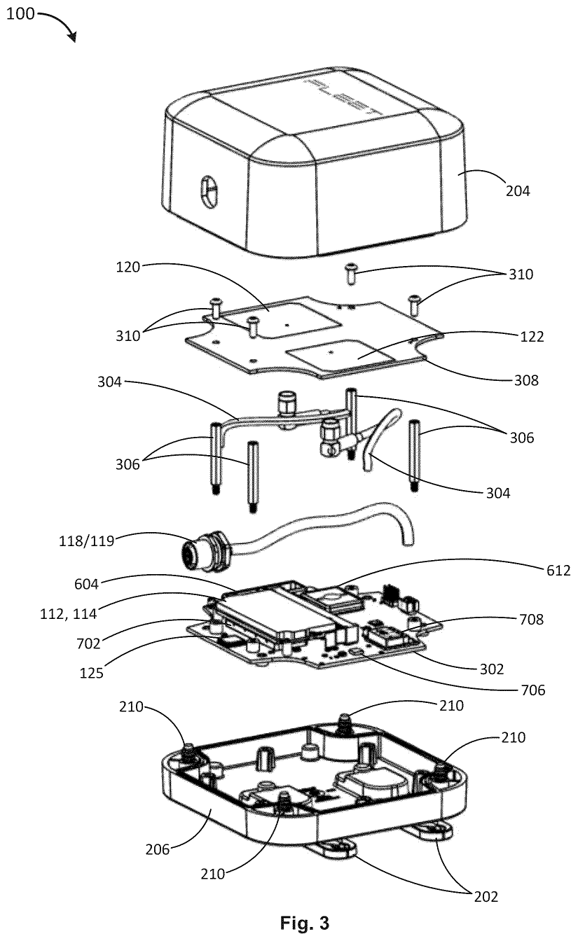

FIG. 3 is an exploded view of the satellite modem 100, according to some embodiments. Satellite modem 100 further comprises main board 302. Main board 302 may be directly coupled to the housing base 206. In some embodiments, the main board 302 may be an approximate square shape. The approximate square shape of the main board 302 may have its four corners removed to allow the main board 302 to fit within the housing 110 without interfering with fasteners (such as coupling bolts 210) at internal corners of the housing. That is, the main board 302 may be shaped to fit around coupling bolts 210, for example. In some embodiments, main board 302 includes, carries, and/or has mounted thereto some, or all of: the processor 112, the memory 114, the communications module 116, and the GPS module 125. In some embodiments, main board 302 may be or include a commercially available System on Module (SoM) 199. The SoM 199 may be an IMX7 (or iMX7) SoM, such as the Colibri IMX7 from Toradex, for example. In some embodiments, main board 302 may further include additional memory 114 to that provided by a commercially available SoM 199.

In some embodiments, data I/O port 118 may be in electrical communication with main board 302. That is, data I/O port 118 may facilitate electrical communication between main board 302 and an external power source 124 and/or an external device 126, for example. In some embodiments, main board 302 further includes at least two Micro-miniature coaxial (MMCX) connection points to connect to respective radio frequency (RF) cables 304.

Satellite modem 100 further comprises an antenna mounting structure to mechanically support the transmit antenna 120 and the receive antenna 122. In some embodiments, the antenna mounting structure may be or include a single antenna board 308. In some embodiments, the antenna mounting structure may comprise a plurality of antenna boards 308. Each antenna board 308 may be formed of commercially available PCB materials. In some embodiments, antenna board 308 may be an approximate square shape. The approximate square shape of the antenna board 308 may have its four corners removed to allow the antenna board 308 to fit within the housing 110. That is, the antenna board 308 may be shaped to fit around coupling bolts 210, for example.

Transmit antenna 120 may be disposed on a first antenna board 308. Receive antenna 122 may be disposed on a second antenna board 308. In some embodiments, transmit antenna 120 and receive antenna 122 may be disposed on one antenna board 308. Antenna board 308 may be coupled to housing base 206 via a plurality of standoffs 306. Standoffs 306 may be commercially available standoffs, for example.

In some embodiments, the antenna board 308 may be coupled to the main board 302 via the plurality of standoffs 306. That is, the antenna board 308 is coupled to the main board 302 rather than the housing base 206 via standoffs 306, for example. Antenna board 308 may be coupled to the plurality of standoffs 306 via a plurality of screws 310. In some embodiments, standoffs 306 may have a height of about 10 mm to about 50 mm. The standoffs may have a height of about 20 mm to about 40 mm, for example. In some embodiments, the standoffs may have a height of about 30 mm.

Antenna board 308 may be in electrical communication with main board 302 via at least two RF cables 304. In some embodiments, each RF cable 304 comprises a male SubMiniature version A (SMA) connector for electrical communication to the antenna board 308. In some embodiments, RF cables 304 comprise a Micro-miniature coaxial (MMCX) connector for electrical communication to the main board 302.

FIGS. 4A and 4B are top and bottom perspective views, respectively, of the antenna board 308 of satellite modem 100, according to some embodiments. FIG. 4C is a top view of the antenna board 308 of satellite modem 100, according to some embodiments. Referring to FIG. 4A and 4C, antenna board 308 includes the transmit antenna 120 and the receive antenna 122 coupled to the top face of the antenna board 308. Antenna board 308 further comprises a plurality of apertures 402 for receiving standoffs 306 and screws 310. The transmit antenna 120 may be adjacent to the receive antenna 122.

Referring to FIG. 4B, antenna board 308 includes two female SMA connectors 404 coupled to the bottom face of the antenna board 308. The transmit antenna 120 is in electrical communication with one of the two female SMA connectors 404. The receive antenna 122 is in electrical communication with the other of the two female SMA connectors 404. The two female SMA connectors 404 facilitate an electrical communication with the main board 302 via the male SMA connectors of RF cables 304. That is, each RF cable 304 may connect to a female SMA connector 404 of the antenna board 306 and a MMCX connection point of the main board 302, to create an electrical communication, for example. In some embodiments, transmit antenna 120 and receive antenna 122 each further include a pass-through electrical connection 436 and 438, respectively, as shown in FIG. 4A. Pass-through 436 and 438 electrical connections may provide transmit antenna 120 and receive antenna 122 with an electrical connection to their respective female SMA connectors 404. In some embodiments, pass-through 436 and 438 are configured to extend through antenna board 308.

When multiple antennas are collocated on a single device, some factors, such as the antenna positions relative to each other and to the ground plane of the antenna board 308, influence the radiation. Therefore, it is important to find the appropriate configuration of antennas which can satisfy all the system requirements related the antenna mutual orientations and locations to the mutual coupling between two identical antennas on an infinite ground plane. The transmit antenna 120 and the receive antenna 122 positions are optimized on the antenna board 308 to provide the required isolation. The isolation between the two ports of the proposed antenna is better than 25 dB across the 1.97-2.01 GHz and 2.17-2.2 GHz.

In some embodiments, the transmit antenna 120 may cover a frequency range of about 1970 MHz to about 2010 MHz. That is, transmit antenna 120 may cover at least one of L band and S band frequency ranges, for example. In some embodiments, the receive antenna 122 may cover a frequency range of about 2170 MHz to about 2200 MHz. That is, receive antenna 122 may cover S band frequency ranges, for example.

FIG. 5 is a schematic diagram of an antenna 500, according to some embodiments. In some embodiments, antenna 500 may be an approximate square shape. In some embodiments, antenna 500 may be a transmit antenna 120. In some embodiments, antenna 500 may be a receive antenna 122. Antenna 500 has an antenna length 502. Antenna 500 has an antenna width 504. In some embodiments, antenna 500 may have two opposing corners of the approximate square shape truncated, or cut off edges. That is, a portion of two opposing corners of antenna 500 may be omitted or removed during manufacture to define an angled truncated corner edge or “cut off edge” at a 45° angle, for example. The removed corners may result in two cut off edges, or truncated corner edges, 508, for example. The cut off edges 508 have a length 506. In some embodiments, antenna 500 may be configured to be right hand circular polarised (RHCP) due to the truncated corner edgess 508, for example.

In some embodiments, the size of antenna 500 is dependent on the desired operating frequency and the dielectric constant of the antenna 500 material. In some embodiments, the positioning of the two female SMA connectors 404 may determine the impedance matching of antenna 500. In some embodiments, the length 506 of the cut off edges 508 may determine the circular polarisation of antenna 500. In some embodiments, passive gain of antenna 500 is determined based on a combination of the size or the antenna 500, the positioning of the two female SMA connectors 404, and the length 506 of the cut off edges 508, for example.

In embodiments where antenna 500 is a transmit antenna 120, the antenna length 502 is about 38.9 mm. In embodiments where antenna 500 is a transmit antenna 120, the antenna width 504 is about 38.9 mm. In embodiments where antenna 500 is a transmit antenna 120, the cut off length 506 is about 4.525 mm. In embodiments where antenna 500 is a receive antenna 122, the antenna length 502 is about 35.45 mm. In embodiments where antenna 500 is a receive antenna 122, the antenna width 504 is about 35.45 mm. In embodiments where antenna 500 is a receive antenna 122, the cut off length 506 is about 4.525 mm.

Antenna 500 is a passive antenna. Antenna 500 may have a passive gain of about 5.5 decibel relative to isotrope (dBi). In some embodiments, the passive gain may be less than 5.5 dBi and greater than 0 dBi or 0.1 dBi. For example, the passive gain may be less than 5.5 dBi and greater than 3.0 dBi. For example, the passive gain may be less than 5.5 dBi and greater than 4.0 dBi. For example, the passive gain may be less than 5.5 dBi and greater than 5.0 dBi. A passive gain of at least 3.0 dBi is beneficial for achieving a suitable data rate for satellite communication with LEO satellites, for example.

In some embodiments, the above described dimensions and/or parameters may be altered to achieve a different passive gain. In embodiments where antenna 500 includes cut off edges 508 as shown in FIGS. 4A, 4C and 5, antenna 500 is a right-hand polarised antenna. In some embodiments, antenna 500 is configured instead as a left-hand polarised antenna. In some embodiments, antenna 500 may be formed of a laminate, such as a hydrocarbon ceramic laminate, for example. The laminate may be a woven glass reinforced hydrocarbon ceramic laminate, such as RO4003C from Rogers Corporation, for example. In some embodiments, antenna 500 may be printed on the antenna mounting structure.

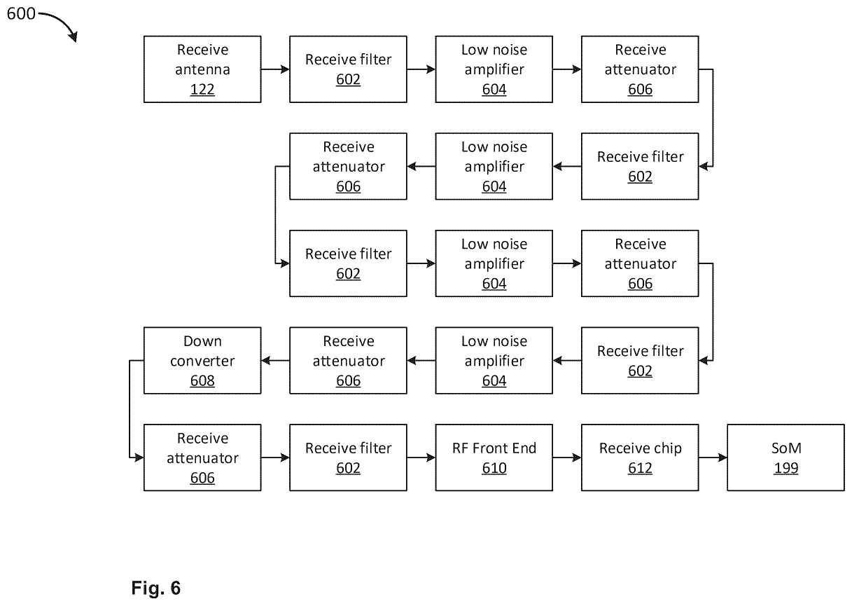

FIG. 6 shows signal processing performed by receive circuitry 600 for receiving RF signals via receive antenna 122. In some embodiments, main board 302 may further include receive circuitry 600. Receive circuitry 600 includes one or a plurality of receive filters 602 for filtering the RF signals received via receive antenna 122. Receive filters 602 may be used to reduce noise and electromagnetic interference in the received signal, for example. Receive filters 602 may be commercially available products, such as surface acoustic wave (SAW) filters, band-pass filters, or a combination thereof, for example. In some embodiments, receive circuitry 600 further includes one or a plurality of low noise amplifiers (LNA) 604 in electrical communication with the receive antenna 122. The one or multiple LNAs 604 may be used to amplify the downlink data signal received via the receive antenna 122 while minimising noise. That is, the one or multiple LNAs 604 may amplify the received RF signal without significantly degrading its signal-to-noise ratio, for example.

In some embodiments, receive circuitry 600 further includes one or multiple receive attenuators 606 in electrical communication with the receive antenna 122. The one or multiple receive attenuators 606 may be used to reduce the power of the received RF signal without degrading its integrity and/or to improve impedance matching of the received signal, for example. The one or multiple receive attenuators 606 may also reduce signal reflection in the received signal, for example. Receive circuitry 600 further includes a down-converter 608 in electrical communication with the receive antenna 122. Down-converter 608 may be used to convert the received RF signal to a target receive signal frequency, such as a LoRa RF signal or an FSK RF signal, for example. Receive circuitry 600 further includes an RF front end 610 in electrical communication with the receive antenna 122. RF front end 610 may be used to automatically control gain, filter the RF signal, and to convert the signal from analogue to digital, for example. RF front end 610 may be a commercially available radio frequency signal processing chip, such as sx1250 from Semtech, for example. The filter 602, LNA 604 and attenuator 606 are preferably arranged as a circuitry combination in series. Where multiple filters 602, LNAs 604 and attenuators 606 are present, they are arranged together in a series of such circuitry combinations. FIG. 6 illustrates an example signal processing flow where multiple (e.g. three) filter/LNA/attenuator circuitry combinations are arranged in series.

Receive circuitry 600 further includes receive chip 612 for decoding data received via receive antenna 122. Receive chip 612 may be used to demodulate the digitally converted analogue signal received via receive antenna 122. Receive chip 612 may be a commercially available product, such as sx1302 from Semtech, for example. The one or multiple receive filters 602, the one or multiple LNAs 604, the one or multiple receive attenuators 606, the down-converter 608, the RF front end 610, and the receive chip 612 are in electrical communication to provide signal processing functionality between the receive antenna 122 and the SoM 199, as shown in FIG. 6.

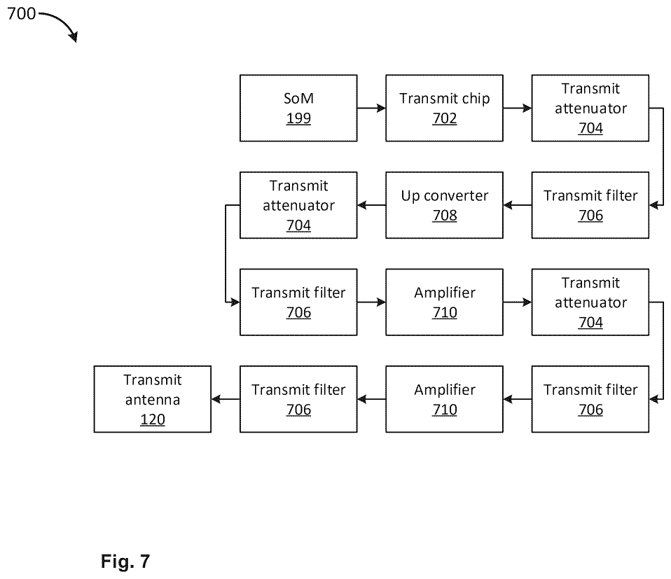

FIG. 7 shows signal processing performed by transmit circuitry 700 for transmitting RF signals via transmit antenna 120. In some embodiments, main board 302 may further include transmit circuitry 700. Transmit circuitry 700 further includes transmit chip 702 for encoding data for transmission via transmit antenna 120. Transmit chip 702 may be used to generate a target transmit signal, such as a LoRa RF signal or an FSK RF signal, for example. The target transmit signal may be in a frequency range of about 900 MHz to about 930 MHz. Transmit chip 702 may be a commercially available product, such as sx1262 from Semtech, for example. In some embodiments, SoM 199 may be configured to instruct the transmit chip 702 using a pre-set instruction set to generate a signal. Transmit chip 702 may have a maximum data rate of up to 300 kbps. In some embodiments, satellite modem 100 may only transmit at a lower than maximum data rate, such as a rate of about 20 kbps, for example.

In some embodiments, transmit circuitry 700 further includes one or multiple transmit attenuators 704 in electrical communication with the transmit antenna 120. Transmit attenuators 704 may be used to reduce the power of the transmitting RF signal without degrading its integrity and/or to improve impedance matching of the transmission signal, for example. Receive attenuators 606 may also reduce signal reflection in the received signal, for example.

Transmit circuitry 700 further includes one or multiple transmit filters 706 for filtering radio signals for transmission via transmit antenna 120. Transmit filters 706 may be used to reduce noise and electromagnetic interference in the transmission signal, for example. Transmit filters 706 may be commercially available products, such as band-pass filters, SAW filters, ceramic coaxial filters, or a combination thereof, for example. Transmit circuitry 700 further includes an up-converter 708 in electrical communication with the transmit antenna 120. Up-converter 708 may be used to convert the target transmit signal to a higher frequency. That is, the up-converter 708 may offset the target transmit signal by about 1270 MHz to a frequency range of about 2170 MHz to about 2200 MHz, for example.

Transmit circuitry 700 further includes a first amplifier 710 and a second amplifier 710 in electrical communication with the transmit antenna 120. Amplifiers 710 may be used to increase the signal strength of the transmission signal. That is, amplifiers 710 may take a lower-power radio-frequency signal and amplify it into a higher-power radio-frequency signal, for example. The first amplifier 710 may increase the signal strength by about 15 decibels (dB), for example. The second amplifier 710 may increase the signal strength by about 28 dB, for example. In some embodiments, the second amplifier 710 may be a 2 watt amplifier, for example. In some embodiments, the RF signal from the up-converter 708 may have a gain of about −10 dB. The first amplifier 710 may increase the gain to about 5 dB, and the second amplifier 710 may further increase the gain to a total active gain of about 30 dB to about 35 dB, for example. The satellite modem 100 may have an active gain of about 33 dB and a passive gain of about 5.5 dBi, for example.

The transmit chip 702, the one or multiple transmit attenuators 704, the one or multiple transmit filters 702, the up-converter 708, the first amplifier 710, and the second amplifier 710 are in electrical communication to provide signal processing functionality between the SoM 199 and the transmit antenna 120, as shown in FIG. 7.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A satellite modem, comprising:
a housing;
a processor in the housing;
a memory in the housing and accessible by the processor;
a communications module in the housing and responsive to the processor to communicate with a local external device;
an antenna mounting structure mounted in the housing;
a transmit patch antenna disposed on the antenna mounting structure and configured to transmit uplink data from the local external device to a satellite;
a receive patch antenna disposed on the antenna mounting structure and configured to receive downlink data from the satellite; and
a power input connection on the housing to receive power from an external power source and to supply power from the external power source to the processor, the communications module, the transmit patch antenna, and the receive patch antenna,
wherein the transmit patch antenna and the receive patch antenna are configured to have a passive gain of 3.0 to 5.5 dBi, and
wherein the processor is configured to operate the transmit patch antenna and the receive patch antenna in full duplex.

2. The satellite modem of claim 1, wherein the transmit patch antenna is configured to operate at a different frequency range to the receive patch antenna.

3. The satellite modem of claim 1, wherein the transmit patch antenna is configured to operate at a frequency range of about 1970 MHz to about 2010 MHz.

4. The satellite modem of claim 1, wherein the receive patch antenna is configured to operate at a frequency range of about 2170MHz to about 2200 MHz.

5. The satellite modem of claim 1, wherein the transmit patch antenna and the receive patch antenna are right hand polarised.

6. The satellite modem of claim 1, wherein the transmit patch antenna is configured to operate in at least one of an L band and an S band frequency range.

7. The satellite modem of claim 1, wherein the receive patch antenna is configured to operate in an S band frequency range.

8. The satellite modem of claim 1, wherein the transmit patch antenna and the receive patch antenna are formed of a hydrocarbon ceramic laminate.

9. The satellite modem of claim 1, wherein the transmit patch antenna and the receive patch antenna are printed onto the antenna mounting structure.

10. The satellite modem of claim 1, wherein the transmit patch antenna and the receive patch antenna have an approximate square shape.

11. The satellite modem of claim 10, wherein two opposing corners of the approximate square shape of the transmit patch antenna are cut off at a 45° angle resulting in opposing cut edges, and wherein the cut edges have a length of about 4.525 mm.

12. The satellite modem of claim 1, wherein the transmit patch antenna has a length and a width of 38.9 mm.

13. The satellite modem of claim 10, wherein two opposing corners of the approximate square shape of the receive patch antenna are cut off at a 45° angle resulting in two cut edges, and wherein the cut edges have a length of about 4.525 mm.

14. The satellite modem of claim 1, wherein the receive patch antenna has a length and a width of about 35.45 mm.

15. The satellite modem of claim 1, wherein the transmit patch antenna and the receive patch antenna are passive antennae.

16. The satellite modem of claim 1, further including a signal generator configured to generate a radiofrequency signal, and an up-converter to shift the generated radiofrequency signal from a first transmit band to a higher second transmit band.

17. The satellite modem of claim 1, further including a down-converter to shift a received radiofrequency signal from a first receive band to a lower second receive band, and a demodulator to demodulate the shifted received radiofrequency signal.

18. The satellite modem of claim 1, further including a global positioning system (GPS) module in the housing and responsive to the processor to allow the processor to determine a geospatial position of the satellite modem.

19. The satellite modem of claim 1, wherein the housing includes a base and a cover coupled to the base, and wherein the base includes mounting feet for mounting the housing to an external surface.
